(19) United States
(12) Patent Application Publication
(10) Pub. No.: US 2022/0347990 A1
(43) Pub. Date: Nov. 3, 2022

(54) FLEXIBLE SHEET OF POLYETHYLENE TEREPHTHALATE AND HEAT-ACTIVATED ADHESIVE, AND THERMAL COOLING STRUCTURE USING THE SAME

(71) Applicant: GM GLOBAL TECHNOLOGY OPERATIONS LLC, Detroit, MI (US)

(72) Inventors: Timothy J. Howe, Royal Oak, MI (US); Omar Dauleh, Royal Oak, MI (US)

(73) Assignee: GM GLOBAL TECHNOLOGY OPERATIONS LLC, Detroit, MI (US)

(21) Appl. No.: 17/244,206

(22) Filed: Apr. 29, 2021

(51) Int. Cl. B32B 27/36; B32B 27/18; B32B 27/16

(52) U.S. Cl. CPC B32B 27/36; B32B 27/18; B32B 27/16; B32B 2307/302; B32B 2307/402; B32B 2307/702; B32B 2307/704; B32B 2310/0843

(57) ABSTRACT

A flexible sheet having enhanced thermal conductivity, electrical isolation and bonding strength includes a first layer of polyethylene terephthalate having opposed first and second sides and an electrical isolation of at least 500 ohms at 2.0 kV DC, and a second layer of heat-activated adhesive attached to and covering the first side. The heat-activated adhesive has a bonding strength of greater than 50 psi, and the first and second layers together have a thermal conductivity of at least 0.7 W/mK. A thermal cooling structure for use with high-voltage battery applications includes the first layer of polyethylene terephthalate, the second layer of heat-activated adhesive, a third layer of thermal interface material attached to and covering the second side of the first layer, and a metallic cooling plate attached to the second layer.

### INTRODUCTION

This disclosure relates to flexible sheets made of layers of polyethylene terephthalate (PET) and heat-activated adhesive, and to thermal cooling structures using such flexible sheets.

In high-voltage battery applications (such as in electric and hybrid automotive vehicles), certain components may be heat-producing (i.e., generating their own heat, such as high-voltage batteries), while other components may be heat-bearing (i.e., not generating their own heat but absorbing heat from other nearby components, such as battery trays and enclosures). Adhesive-backed PET films may be used in such environments to physically interface between heat-bearing or heat-producing components and other components (e.g., heat sinks), in order to transfer heat from such heat-bearing or heat-producing components and into the other components. In addition to providing sufficient thermal conductivity, adhesive-backed PET films should also provide sufficient electrical isolation between electrical components (like high-voltage batteries) and other components. Further, adhesive-backed PET films should also provide sufficient bonding strength due to the g-forces that may be produced in environments such as automotive vehicles. However, it is a challenge to find adhesive-backed PET films which have the desired combination of thermal conductivity, electrical isolation and bonding strength.

### SUMMARY

According to one embodiment, a flexible sheet having enhanced thermal conductivity, electrical isolation and bonding strength includes a first layer of polyethylene terephthalate having opposed first and second sides and an electrical isolation of at least 500 ohms at 2.0 kV DC, and a second layer of heat-activated adhesive attached to and covering the first side, wherein the heat-activated adhesive has a bonding strength of greater than 50 psi, and wherein the first and second layers together have a thermal conductivity of at least 0.7 W/mK.

The second side may have a surface roughness of at least one of Rₐ≥0.5 μm and R_{z}≥3.0 μm, and the thermal conductivity of the first layer and second layers together may be at least 1.0 W/mK. The flexible sheet may further include a third layer of thermal interface material attached to and covering the second side. The thermal interface material may be at least one of: (i) a phase change material; and (ii) an adhesive, a silicone, a urethane or an acrylic, containing at least one of pyrolitic graphite, aluminum oxide, magnesium oxide, aluminum nitride, boron nitride, diamond powder and silver. The flexible sheet may further include a metallic cooling plate attached to the second layer of heat-activated adhesive. The metallic cooling plate may include one or more cooling channels therein, wherein each of the one or more cooling channels is configured for containing a flow of coolant therethrough.

One or more of the following may be true with regard to the flexible sheet: (i) the first layer may be colored; (ii) the heat-activated adhesive may be capable of activation by exposure to laser light; (iii) the heat-activated adhesive may be a thermoset heat-activated adhesive; (iv) the heat-activated adhesive may be a thermoplastic heat-activated adhesive; (v) the polyethylene terephthalate may be crystalline; (vi) the polyethylene terephthalate may be amorphous; (vii) the polyethylene terephthalate may be a combination of crystalline and amorphous; and (viii) the polyethylene terephthalate may be a biaxially oriented polyethylene terephthalate.

According to another embodiment, a pliable sheet having enhanced thermal conductivity, electrical isolation and bonding strength includes: a first layer of polyethylene terephthalate having opposed first and second sides and an electrical isolation of at least 500 ohms at 2.0 kV DC; and a second layer of heat-activated adhesive attached to and covering the first side, wherein the heat-activated adhesive has a bonding strength of greater than 50 psi; wherein the polyethylene terephthalate is amorphous, the heat-activated adhesive is a thermoset heat-activated adhesive, and the first and second layers together have a thermal conductivity of at least 1.0 W/mK. The second side may have a surface roughness of at least one of Rₐ≥0.5 μm and R_{z}≥3.0 μm.

According to yet another embodiment, a thermal cooling structure for use with high-voltage battery applications includes: (i) a first layer of polyethylene terephthalate having opposed first and second sides and an electrical isolation of at least 500 ohms at 2.0 kV DC; (ii) a second layer of heat-activated adhesive attached to and covering the first side, wherein the heat-activated adhesive has a bonding strength of greater than 50 psi and the first and second layers together have a thermal conductivity of at least 0.7 W/mK; (iii) a third layer of thermal interface material attached to and covering the second side; and (iv) a metallic cooling plate attached to the second layer of heat-activated adhesive.

The thermal interface material may be at least one of: (i) a phase change material; and (ii) an adhesive, a silicone, a urethane or an acrylic, containing at least one of pyrolitic graphite, aluminum oxide, magnesium oxide, aluminum nitride, boron nitride, diamond powder and silver. The metallic cooling plate may include one or more cooling channels therein, wherein each of the one or more cooling channels is configured for containing a flow of coolant therethrough. The polyethylene terephthalate may be amorphous, and the heat-activated adhesive may be a thermoset heat-activated adhesive.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic exploded side view of a flexible sheet and a thermal cooling structure.

FIG. 2 is a schematic assembled side view of the flexible sheet and thermal cooling structure of FIG. 1.

FIG. 3 is a cooling profile for the flexible sheet and thermal cooling structure of FIG. 2.

FIG. 4 is a block diagram illustrating various properties of a thermal interface material for use in the flexible sheet and thermal cooling structure of FIGS. 1-2.

FIG. 5 is a block diagram illustrating various properties of a PET material for use in the flexible sheet and thermal cooling structure of FIGS. 1-2.

FIGS. 6-7 are block diagrams illustrating various properties of a heat-activated adhesive material for use in the flexible sheet and thermal cooling structure of FIGS. 1-2.

### DETAILED DESCRIPTION

Referring now to the drawings, wherein like numerals indicate like parts in the several views, a flexible or pliable sheet 70 having enhanced thermal conductivity, electrical isolation and bonding strength, and a thermal cooling structure 80 for use with high-voltage battery applications, are shown and described herein. Note that as used herein, the descriptors “flexible” and “pliable” may be used interchangeably.

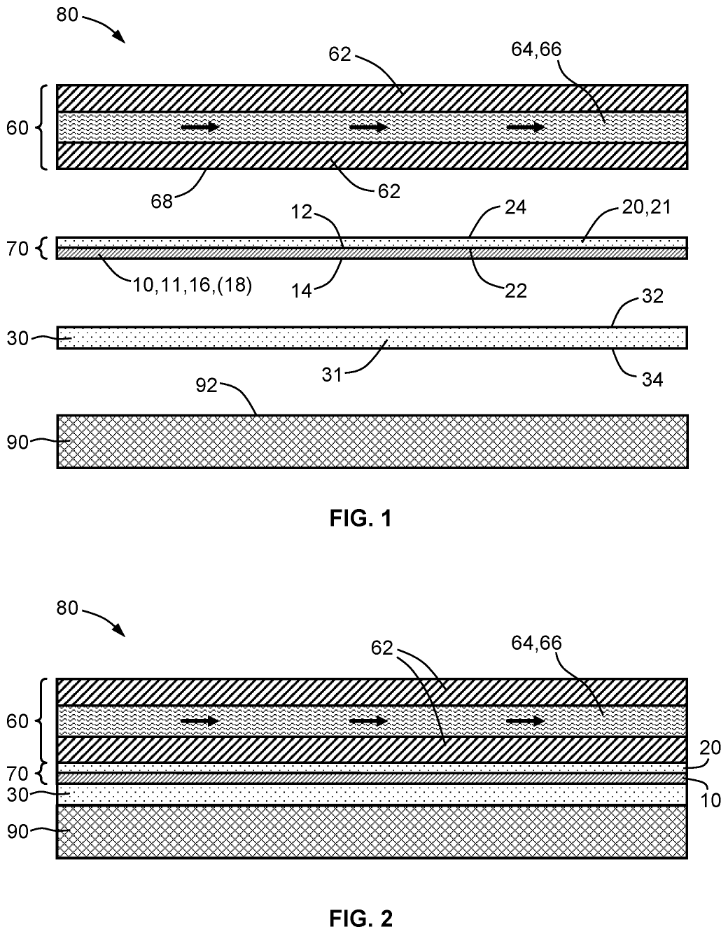

FIGS. 1-2 show schematic exploded and assembled side views, respectively, of the flexible sheet 70 and thermal cooling structure 80, their components, and an exemplary environment or application in which the flexible sheet 70 and/or thermal cooling structure 80 may be used. According to one embodiment, the flexible sheet 70 and thermal cooling structure 80 include a first layer 10 of polyethylene terephthalate or PET material 11 (hereinafter sometimes referred to as a PET film 10) having opposed first and second sides 12, 14, and a second layer 20 of heat-activated adhesive 21 having opposed third and fourth sides 22, 24, with the first and second layers 10, 20 sandwiched together with the third side 22 attached to and covering the first side 12. The first layer 10 of polyethylene terephthalate or PET material 11 is selected, formulated and/or configured to have an electrical isolation of at least 500 ohms at 2.0 kV DC, and the heat-activated adhesive 21 is selected, formulated and/or configured to have a bonding strength of greater than 50 psi. (That is, the second layer 20 of heat-activated adhesive 21 may be selected, formulated and/or configured to have a bonding strength of greater than 50 psi.) Further, the first and second layers 10, 20 are selected, formulated and/or configured so that together they have a thermal conductivity of at least 0.7 W/mK. In other words, the first layer 10 of polyethylene terephthalate or PET material 11 and the second layer 20 of heat-activated adhesive 21, attached together, have a thermal conductivity of at least 0.7 W/mK.

The second side 14 of the first layer 10 may be roughened (either as formed or through a post-processing step), so as to enhance its bondability with other materials or components. For example, the second side 14 may have a surface roughness of at least one of Rₐ≥0.5 μm and R_{z}≥3.0 μm. (For example, the second side 14 may have (i) an average surface roughness Rₐ of 0.5 μm or more, such as 2-3 μm or more, and/or (ii) a range of surface roughness R_{z} between the highest and lowest points of the surface of 3.0 μm or more, such as 5-6 μm or more.) Optionally, the thermal conductivity requirements of the first and second layers 10, 20 together may be altered; for example, the thermal conductivity of the first and second layers 10, 20 together may be at least 1.0 W/mK.

The flexible sheet 70 and thermal cooling structure 80 may further include a third layer 30 of thermal interface material 31 having opposed fifth and sixth sides 32, 34, with the fifth side 32 attached to and covering the second side 14 of the first layer 10. As illustrated by the block diagram of FIG. 4, the thermal interface material 31 may be a phase change material 36, such as a paraffin-based wax material or an acrylic-based material; additionally or alternatively, the thermal interface material 31 may be a “carrier” such as an adhesive 38, a silicone 40, a urethane 42 or an acrylic 44, containing at least one “filler” such as one or more of pyrolitic graphite 46, aluminum oxide 48, magnesium oxide 50, aluminum nitride 52, boron nitride 54, diamond powder 56 and silver 58.

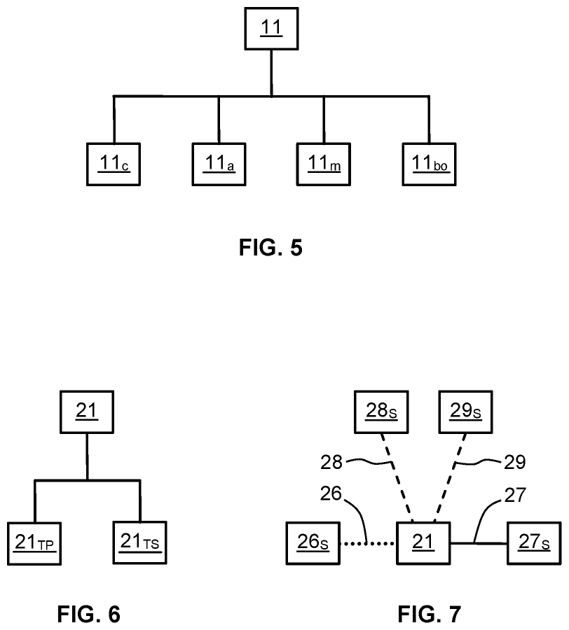

FIG. 5 illustrates various properties of the polyethylene terephthalate or PET material 11 of the first layer 10. The PET material 11 may be a crystalline polyethylene terephthalate 11_{c}, an amorphous polyethylene terephthalate 11ₐ, a “mixed” polyethylene terephthalate 11ₘ containing a combination of crystalline polyethylene terephthalate 11_{c} and amorphous polyethylene terephthalate Ila, and/or a biaxially oriented polyethylene terephthalate 11_{bo} (sometimes referred to as “BOPET”). Optionally, the PET material 11 may be black, white or colored, as well as being translucent or opaque. Additionally, as shown in FIG. 1, the PET material 11 of the first layer 10 may include pure polyethylene terephthalate 16 only, or optionally it may also include one or more fillers or additives 18 added to the pure polyethylene terephthalate 16. (Reference numeral 18 is shown in parentheses in FIG. 1 to indicate that the fillers or additives 18 are optional.) These one or more fillers or additives 18 may be included to enhance one or more properties of the overall PET material 11, such as the thermal, electrical and/or optical properties thereof.

FIGS. 6-7 illustrate various properties of the heat-activated adhesive 21 of the second layer 20. The heat-activated adhesive 21 may be a thermoplastic heat-activated adhesive 21_{TP} or a thermoset heat-activated adhesive 21_{TS}. If the heat-activated adhesive 21 is a thermoplastic heat-activated adhesive 21_{TP}, the formulation of the thermoplastic heat-activated adhesive 21_{TP} may be selected such that its melting point is higher than the environment in which the thermoplastic heat-activated adhesive 21_{TP} is to be used. The heat-activated adhesive 21 may be capable of being heated and/or activated by one or more approaches. (As used here, “activation” or being “activated” for a thermoplastic heat-activated adhesive 21_{TP} means being heated to its melting point or higher, and for a thermoset heat-activated adhesive 21_{TS} means being heated so as to initiate cross-linking, chemical bonding or the like.) For example, the heat-activated adhesive 21 may be heated or activated by convective heat 26 from a convective heat source 26_{S}, by conductive heat 27 from a conductive heat source 27_{S}, by radiant heat 28 from a radiant heat source 28_{S}, and/or by exposure to laser light 29 of one or more particular frequencies from a laser light source 29_{S}.

The flexible sheet 70 and thermal cooling structure 80 may further include a metallic cooling plate 60 having a seventh side 68 which is attached to the fourth side 24 of the second layer 20. The metallic cooling plate 60 has a body portion 62 made of aluminum, copper, steel or the like, with the body portion 62 having one or more cooling channels 64 therein. Each of the one or more cooling channels 64 is configured for containing a flow of coolant 66 therethrough, such as a liquid coolant. The coolant 66 may be circulated through the one or more channels 64 by a pump or other system (not shown).

With the flexible sheet 70 and thermal cooling structure 80 arranged as variously described above, the flexible sheet 70 or thermal cooling structure 80 may be disposed in contact with a heat-bearing or heat-producing workpiece 90 as illustrated in FIG. 2, in order to help cool the workpiece 90. For example, the workpiece 90 may be a high-voltage battery, a battery tray, a battery enclosure, an electrical/electronic component, a housing for an electrical/electronic component, or other device or object which may benefit from cooling and/or heat dissipation.

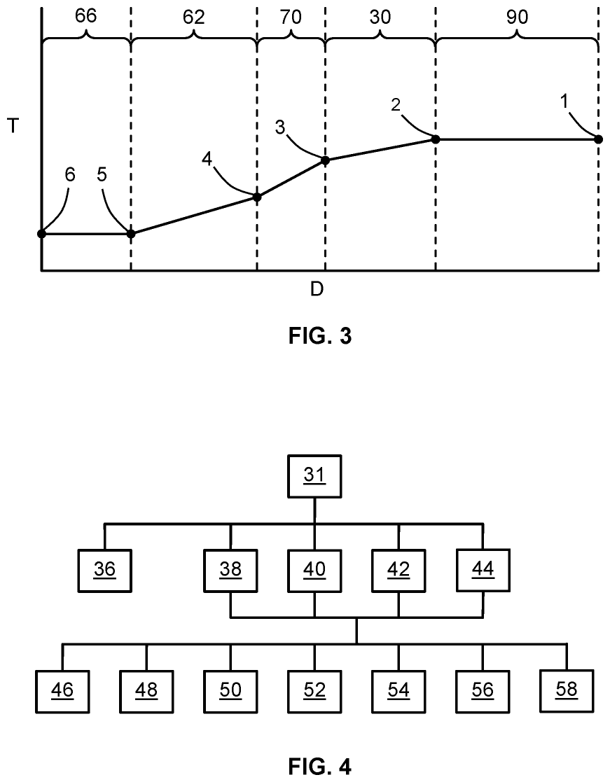

FIG. 3 shows a cooling profile for the flexible sheet 70 and thermal cooling structure 80 of FIG. 2. The vertical axis represents temperature T and the horizontal axis represents distance D from the center of the coolant channel 64. The horizontal line from point 1 to point 2 represents the temperature of the workpiece 90, the sloped line from point 2 to point 3 represents the temperature within the third layer 30 of thermal interface material 31, the sloped line from point 3 to point 4 represents the temperature within the flexible or pliable sheet 70, the sloped line from point 4 to point 5 represents the temperature within the body portion 62 of the metallic cooling plate 60, and the horizontal line from point 5 to point 6 represents the temperature of the coolant 66 within the metallic cooling plate 60. It should be noted that the distances D and temperatures T of the various points 1-6 are not necessarily to-scale; however, the temperature or cooling profile defined by the points 1-6 illustrates that the various layers or portions of the flexible sheet 70 and thermal cooling structure 80 are effective to draw heat away from the workpiece 90.

The materials and components used in the flexible sheet 70 and thermal cooling structure 80 may have various properties, such as the exemplary properties shown below in TABLE 1 below. An industry or engineering standard is provided for selected properties for the sake of reference. Note that these are merely exemplary or example properties and standards, and are not intended to limit or define the selected materials or components. For example, the electrical isolation (also known as dielectric resistance) may be 500 ohms or more at 2.0 kilovolts of direct current (i.e., kV DC), or 500 ohms or more at some higher DC voltage level such as 2.1 kV, 2.8 kV, 3.5 kV, etc. Similarly, the bond strength may be greater than 50 psi (thus excluding conventional pressure-sensitive adhesives), or the bond strength may be required to be greater than 300 psi in shear and/or greater than 270 psi in tensile strength.

TABLE 1
Table of Properties for Selected Materials and Components

| Material or Component | Property | Standard |
|---|---|---|
| Electrical isolation | ≥500 ohms @ 2.0 kV DC | ASTM D149 |
| Thermal conductivity | ≥0.7 W/mK | ASTM D5470 |
| Bond strength | >50 psi; or | ASTM D3528, |
| | >300 psi (2.1 MPa) shear, | ASTM D3433-99, |
| | >270 psi (1.9 MPa) tensile | ASTM D2095 |
| PET film surface roughness | Rₐ ≥0.5 μm and/or R_{z} ≥3.0 μm | ASTM D4417, method A |
| PET film density | ≤1.38 g/cm³ | — |
| PET film coefficients of friction | ≥0.5 kinetic, ≥0.7 static | ASTM D1894-90 |
| PET film color | 0 (black) | 0 to 255 grayscale range |
| PET film stiffness | >50 psi, <11 ksi | — |
| PET film flammability rating | VTM-0 or VTM-1 | UL 94 VTM |

According to another embodiment, a pliable sheet 70 having enhanced thermal conductivity, electrical isolation and bonding strength includes: a first layer 10 of polyethylene terephthalate 11 having opposed first and second sides 12, 14 and an electrical isolation of at least 500 ohms at 2.0 kV DC; and a second layer 20 of heat-activated adhesive 21 attached to and covering the first side 12, wherein the heat-activated adhesive 21 has a bonding strength of greater than 50 psi; wherein the polyethylene terephthalate 11 is amorphous (i.e., an amorphous polyethylene terephthalate 11ₐ), the heat-activated adhesive 21 is a thermoset heat-activated adhesive 21_{TS}, and the first and second layers 10, 20 together have a thermal conductivity of at least 1.0 W/mK. The second side 14 may have a surface roughness of at least one of Rₐ≥0.5 μm and R_{z}≥3.0 μm.

According to yet another embodiment, a thermal cooling structure 80 for use with high-voltage battery applications (and other applications) includes: (i) a first layer 10 of polyethylene terephthalate 11 having opposed first and second sides 12, 14 and an electrical isolation of at least 500 ohms at 2.0 kV DC; (ii) a second layer 20 of heat-activated adhesive 21 attached to and covering the first side 12, wherein the heat-activated adhesive 21 has a bonding strength of greater than 50 psi and the first and second layers 10, 20 together have a thermal conductivity of at least 0.7 W/mK; (iii) a third layer 30 of thermal interface material 31 attached to and covering the second side 14; and (iv) a metallic cooling plate 60 attached to the second layer 20 of heat-activated adhesive 21.

The thermal interface material 31 may be at least one of: (i) a phase change material 36; and (ii) an adhesive 38, a silicone 40, a urethane 42 or an acrylic 44, containing at least one of pyrolitic graphite 46, aluminum oxide 48, magnesium oxide 50, aluminum nitride 52, boron nitride 54, diamond powder 56 and silver 58. The metallic cooling plate 60 may include one or more cooling channels 64 therein, wherein each of the one or more cooling channels 64 is configured for containing a flow of coolant 66 therethrough. The polyethylene terephthalate 11 may be amorphous (i.e., an amorphous polyethylene terephthalate 11ₐ), and the heat-activated adhesive 21 may be a thermoset heat-activated adhesive 21_{TS}.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A flexible sheet having enhanced thermal conductivity, electrical isolation and bonding strength, comprising:
a first layer of polyethylene terephthalate having opposed first and second sides and an electrical isolation of at least 500 ohms at 2.0 kV DC; and
a second layer of heat-activated adhesive attached to and covering the first side;
wherein the heat-activated adhesive has a bonding strength of greater than 50 psi, and wherein the first and second layers together have a thermal conductivity of at least 0.7 W/mK.

2. The flexible sheet of claim 1, wherein the second side has a surface roughness of at least one of Rₐ≥0.5 μm and R_{z}≥3.0 μm.

3. The flexible sheet of claim 1, wherein the thermal conductivity of the first layer and second layers together is at least 1.0 W/mK.

4. The flexible sheet of claim 1, further comprising:
a third layer of thermal interface material attached to and covering the second side, wherein the thermal interface material is at least one of:
a phase change material, and
an adhesive, a silicone, a urethane or an acrylic, containing at least one of pyrolitic graphite, aluminum oxide, magnesium oxide, aluminum nitride, boron nitride, diamond powder and silver.

5. The flexible sheet of claim 1, further comprising:
a metallic cooling plate attached to the second layer of heat-activated adhesive.

6. The flexible sheet of claim 5, wherein the metallic cooling plate includes one or more cooling channels therein, wherein each of the one or more cooling channels is configured for containing a flow of coolant therethrough.

7. The flexible sheet of claim 1, wherein the first layer is colored.

8. The flexible sheet of claim 1, wherein the heat-activated adhesive is capable of activation by exposure to laser light.

9. The flexible sheet of claim 1, wherein the heat-activated adhesive is a thermoset heat-activated adhesive.

10. The flexible sheet of claim 1, wherein the heat-activated adhesive is a thermoplastic heat-activated adhesive.

11. The flexible sheet of claim 1, wherein the polyethylene terephthalate is crystalline.

12. The flexible sheet of claim 1, wherein the polyethylene terephthalate is amorphous.

13. The flexible sheet of claim 1, wherein the polyethylene terephthalate is a combination of crystalline and amorphous.

14. The flexible sheet of claim 1, wherein the polyethylene terephthalate is a biaxially oriented polyethylene terephthalate.

15. A pliable sheet having enhanced thermal conductivity, electrical isolation and bonding strength, comprising:
a first layer of polyethylene terephthalate having opposed first and second sides and an electrical isolation of at least 500 ohms at 2.0 kV DC; and
a second layer of heat-activated adhesive attached to and covering the first side, wherein the heat-activated adhesive has a bonding strength of greater than 50 psi;
wherein the polyethylene terephthalate is amorphous, the heat-activated adhesive is a thermoset heat-activated adhesive, and the first and second layers together have a thermal conductivity of at least 1.0 W/mK.

16. The pliable sheet of claim 15, wherein the second side has a surface roughness of at least one of Rₐ≥0.5 μm and R_{z}≥3.0 μm.

17. A thermal cooling structure for use with high-voltage battery applications, comprising:
a first layer of polyethylene terephthalate having opposed first and second sides and an electrical isolation of at least 500 ohms at 2.0 kV DC;
a second layer of heat-activated adhesive attached to and covering the first side, wherein the heat-activated adhesive has a bonding strength of greater than 50 psi and the first and second layers together have a thermal conductivity of at least 0.7 W/mK;
a third layer of thermal interface material attached to and covering the second side; and
a metallic cooling plate attached to the second layer of heat-activated adhesive.

18. The thermal cooling structure of claim 17, wherein the thermal interface material is at least one of:
a phase change material, and
an adhesive, a silicone, a urethane or an acrylic, containing at least one of pyrolitic graphite, aluminum oxide, magnesium oxide, aluminum nitride, boron nitride, diamond powder and silver.

19. The thermal cooling structure of claim 17, wherein the metallic cooling plate includes one or more cooling channels therein, wherein each of the one or more cooling channels is configured for containing a flow of coolant therethrough.

20. The thermal cooling structure of claim 17, wherein the polyethylene terephthalate is amorphous, and the heat-activated adhesive is a thermoset heat-activated adhesive.
